(19) United States
(12) Patent Application Publication
(10) Pub. No.: US 2019/0383471 A1
(43) Pub. Date: Dec. 19, 2019

(54) LIGHT-EMITTING DEVICE AND TERMINAL

(71) Applicant: GUANGDONG OPPO MOBILE TELECOMMUNICATIONS CORP., LTD., Dongguan (CN)

(72) Inventors: Yugui LIN, Dongguan (CN); Jiao CHENG, Dongguan (CN)

(21) Appl. No.: 16/555,991

(22) Filed: Aug. 29, 2019

Related U.S. Application Data
(63) Continuation of application No. PCT/CN2017/115421, filed on Dec. 11, 2017.

(30) Foreign Application Priority Data
Mar. 31, 2017 (CN) 201720335271.1

(51) Int. Cl. F21V 17/16; F21V 8/00; F21V 3/00; F21V 21/14; F21V 23/00

(52) U.S. Cl. CPC F21V 17/16; G02B 6/0073; F21Y 2115/10; F21V 21/14; F21V 23/003; F21V 3/00

(57) ABSTRACT

A light-emitting device and a terminal are provided. The light-emitting device includes a flexible screen and a surface light source. The flexible screen includes an exit light surface and an incident light surface opposite the exit light surface. The surface light source is attached to the incident light surface and configured to emit light, and the light emitted by the surface light source passes through the incident light surface and exits from the exit light surface.

### CROSS-REFERENCE TO RELATED APPLICATIONS

This application is a continuation of International Application No. PCT/CN2017/115421, filed on Dec. 11, 2017, which claims priority to Chinese Patent Application No. 201720335271.1, filed on Mar. 31, 2017, the entire disclosures of which are incorporated herein by reference.

### TECHNICAL FIELD

This disclosure relates to the field of electronic devices, and particularly to a light-emitting device and a terminal.

### BACKGROUND

With the rapid development of terminals such as smartphones, the ordinary terminals are no longer sufficient for the requirements of consumers. A terminal having a flexible screen is a trend in the future. Light-emitting elements of the existing flexible screen are point light sources and fixedly installed. During bending the flexible screen, the light-emitting elements may be completely or partially covered by the flexible screen bent, resulting in low illumination brightness and a narrow illumination range of the light-emitting elements, and even poor illumination effect.

### SUMMARY

According to the present disclosure, a light-emitting device and a terminal are provided.

According to the present disclosure, a light-emitting device is provided. The light-emitting device includes a flexible screen and a surface light source. The flexible screen includes an exit light surface and an incident light surface opposite the exit light surface. The surface light source is attached to the incident light surface and configured to emit light. The light emitted by the surface light source passes through the incident light surface and exits from the exit light surface.

According to the present disclosure, a terminal is further provided. The terminal includes a flexible screen, a surface light source, a flexible screen support member, a bending sensing chip, and a mainboard. The flexible screen includes an exit light surface and an incident light surface opposite the exit light surface. The surface light source is attached to the incident light surface and configured to emit light. The light emitted by the surface light source passes through the incident light surface and exits from the exit light surface. The flexible screen support member is operable to support the flexible screen. The bending sensing chip is disposed on the flexible screen support member and configured to sense a bending degree of the flexile screen support member. The mainboard is configured to control brightness of the light emitted by the surface light source according to the bending degree of the flexible screen support member.

### BRIEF DESCRIPTION OF THE DRAWINGS

To describe technical solutions of the present disclosure more clearly, the following briefly introduces the accompanying drawings required for describing the embodiments. Apparently, the accompanying drawings in the following description only illustrate some embodiments of the present disclosure. Those of ordinary skill in the art may also obtain other drawings based on these accompanying drawings without creative efforts.

FIG. 1 is an exploded schematic structural view of a light-emitting device according to a first embodiment of the present disclosure.

FIG. 2 is a top view of the light-emitting device according to the first embodiment of the present disclosure.

FIG. 3 is another exploded schematic structural view of the light-emitting device according to the first embodiment of the present disclosure.

FIG. 4 is a schematic view illustrating a light-emitting effect of a first light-emitting device bent according to the present disclosure.

FIG. 5 is a schematic view illustrating a light-emitting effect of a second light-emitting device bent according to the present disclosure.

FIG. 6 is a schematic view illustrating a light-emitting effect of a third light-emitting device bent according to the present disclosure.

FIG. 7 is a partial schematic structural view of a surface light source of a light-emitting device according to an embodiment of the present disclosure.

FIG. 8 is a partial schematic structural view of a surface light source of a light-emitting device according to an embodiment of the present disclosure.

FIG. 9 is a partial schematic structural view of a surface light source of a light-emitting device according to an embodiment of the present disclosure.

FIG. 10 is an exploded schematic structural view of a light-emitting device according to a second embodiment of the present disclosure.

FIG. 11 is a schematic structural view of a flexible screen support member of a light-emitting device according to an embodiment of the present disclosure.

FIG. 12 is a schematic cross-sectional view of an engaging member taken along AA′ of FIG. 11.

FIG. 13 is a schematic structural view of a terminal according to an embodiment of the present disclosure.

FIG. 14 is an exploded schematic structural view of a terminal according to an embodiment of the present disclosure.

### DETAILED DESCRIPTION

In order to appreciate the above objects, features, and advantages of the present disclosure more clearly, the present disclosure will be described in detail hereinafter with reference to the accompanying drawings and the specific embodiments. It is noted that the embodiments of the present disclosure and the features in the embodiments can be mutually combined in a condition without inconsistency.

In the following description, various specific details are elaborated to fully appreciate the present disclosure. The described embodiments are merely some rather than all embodiments of the present disclosure. All other embodiments obtained by those of ordinary skill in the art based on the embodiments of the present disclosure without creative efforts shall fall within the protection scope of the present disclosure.

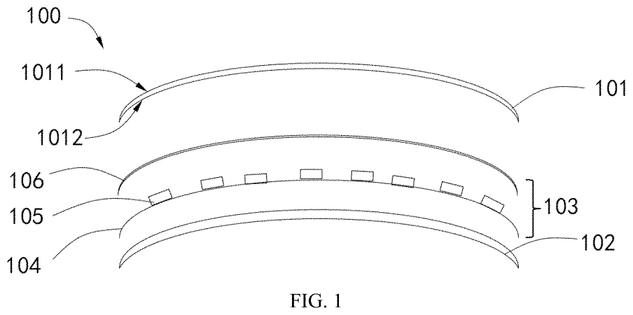

Referring to FIG. 1, a light-emitting device 100 is provided according to an embodiment of the present disclosure. The light-emitting device 100 includes a flexible screen 101, a flexible screen support member 102, and a surface light source 103. The flexible screen 101 includes an exit light surface 1011 and an incident light surface 1012 opposite the exit light surface 1011. The surface light source 103 is attached to the incident light surface 1012 and configured to emit light. The light emitted by the surface light source 103 passes through the incident light surface 1012 and exits from the exit light surface 1011, so as to achieve illumination. The flexible screen 101 is made from a transparent material or a translucent material. In an embodiment, the flexible screen 101 is made from the transparent material, and the flexible screen 101 has good light transmittance, such that the light emitted from the surface light source 103 is transmitted out of the flexible screen 101 to increase brightness of the light-emitting device 100.

According to the present disclosure, the light-emitting device 100 is provided. The surface light source 103 is arranged below the flexible screen 101, such that a light-emitting area of the flexible screen illumination source is increased, and a problem of low brightness of emitted light and a narrow illumination range can be resolved, where the problem is generated by that a light source is covered during bending the flexible screen 101. Thus, the illumination function of the light-emitting device 100 is not affected by a variation in the shape of the flexible screen 101. Further, the surface light source 103 is enabled to form a curved surface light source during bending the flexible screen 101, such that the illumination range of the flexible screen 101 is further increased, thereby increasing the application scenarios of the flexible screen 101. The flexible display can be applied to a poor illumination environment, bringing convenience for people's life.

### First Embodiment

Referring to FIG. 1, the light-emitting device 100 includes the flexible screen support member 102. The flexible screen support member 102, the flexible screen 101, and the surface light source 103 are stacked together. The flexible screen support member 102 is disposed at a side of the surface light source 103 away from the flexible screen 101. The flexible screen support member 102 supports the flexible screen 101 and the surface light source 103, such that the shape of the flexible screen 101 and the shape of the surface light source 103 vary following the variation in the shape of the flexible screen support member 102.

In this embodiment, the surface light source 103 is attached to the flexible screen support member 102, such that the shape of the surface light source 103 varies following the variation in the shape of the flexible screen support member 102.

In this embodiment, the flexible screen support member 102 is bendable. The flexible screen support member 100 can be bent to be in a C-shape or an S-shape, enabling the flexible screen 101 and the surface light source 103 to be bent to be in a C-shape or an S-shape.

In one embodiment, referring to FIG. 1, the surface light source 103 includes a flexible circuit board 104 and multiple surface-mount device light-emitting diodes (SMD LEDs) 105 attached to the flexible circuit board 104. The multiple SMD LEDs 105 are disposed at a side of the flexible circuit board 101 close to the flexible screen 101, such that light emitted from the multiple SMD LEDs 105 can exit from the flexible screen 101.

In another embodiment, the surface light source 103 may also be an organic light-emitting diode (OLED) light source or the like.

In one embodiment, the brightness of the surface light source 103 varies during switching the flexible screen 101 from flattened status to bent status.

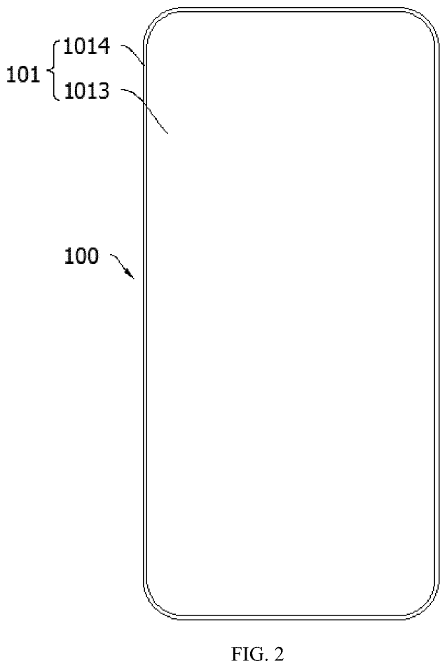

In one embodiment, referring to FIG. 2, the flexible screen 101 includes a display region 1013 and a non-display region 1014 surrounding the display region 1013. A ratio of an area of the display region 1013 to an area of the non-display region 1014 is greater than 4:1.

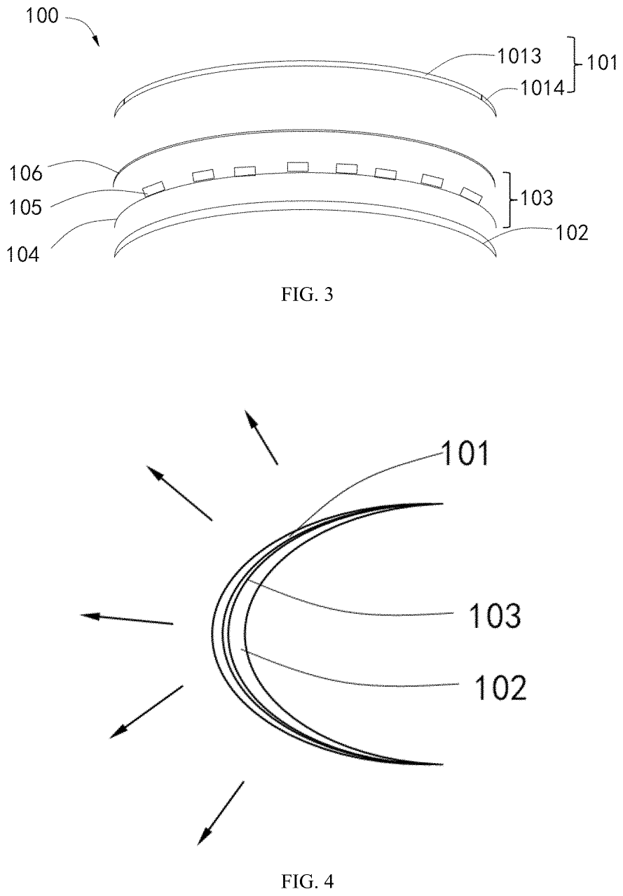

In one embodiment, referring to FIG. 3, a projection of the display region 1013 of the flexible screen 101 in a direction toward the surface light source 103 falls on the surface light source 103, such that the whole display region 1013 of the flexible screen 101 is a light-emitting surface, thereby increasing the light-emitting area of the flexible screen 101.

In this embodiment, the surface light source 103 may be bent following bending of the flexible screen support member 102 and the flexible screen 101, and the bending enables the flexible screen 101 to form a curved-surface light-emitting screen, thereby increasing an illumination angle of the light-emitting device 100. The flexible screen support member 102 is bendable and can be bent to be in any shape, such that the light-emitting device 100 can also be bent to be in any shape. Various bending shapes of the flexible screen support member 102 enable the adjustment of the illumination angle and the illumination angle of the light-emitting device 100. Three embodiments are embodied hereinafter according to the present disclosure for explanations.

In a first embodiment, referring to FIG. 4, the light-emitting device 100 is bent outward. Specifically, two ends of the flexible screen support member 102 are enabled to be close to each other, such that a central portion of the flexible screen support member 102 extends toward a side where the exit light surface 1011 locates, that is, the central portion of the flexible screen support member 102 lies ahead of the two ends of the flexible screen support member 102 in the direction of the light emitted. The flexible screen 101 and the surface light source 103 are bent together with the flexible screen support member 102, enabling the light-emitting device 100 to be a convex surface light source and the light emitted is diverged, thereby increasing the illumination angle.

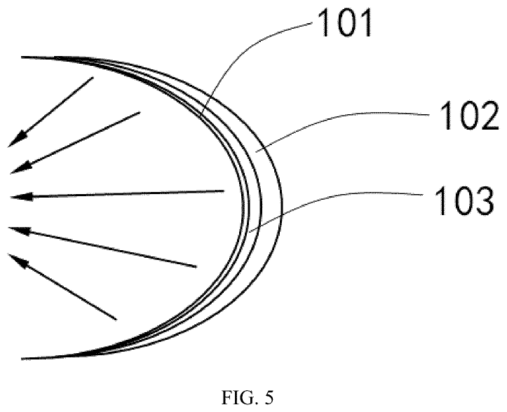

In a second embodiment, referring to FIG. 5, the light-emitting device 100 is bent inward. Specifically, the two ends of the flexible screen support member 102 are enabled to be close to each other, such that the central portion of the flexible screen support member 102 extends toward a side where the incident light surface 1012 locates, that is, the central portion of the flexible screen support member 102 lies behind the two ends of the flexible screen support member 102 in a direction of the light emitted. The flexible screen 101 and the surface light source 103 are bent together with the flexible screen support member 102, enabling the light-emitting device 100 to be a concave surface light source, and the light emitted is concentrated, thereby increasing the illumination brightness.

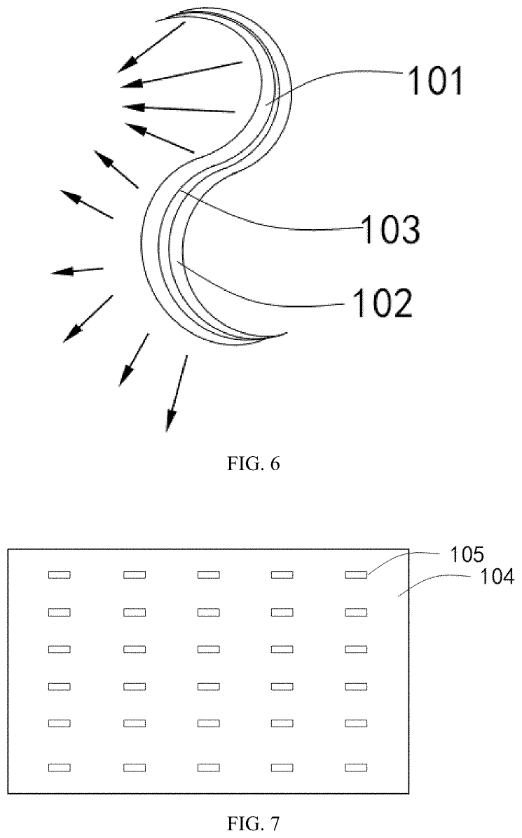

In a third embodiment, referring to FIG. 6, the light-emitting device 100 is bent in an S-shape. The flexible screen 101 and the surface light source 103 are bent together with the flexible screen support member 102, enabling the light-emitting device 100 to be a light-emitting surface having a concave surface and a convex surface, and thus part of the light emitted is concentrated and the other of the light emitted is diverged, thereby increasing the illumination angle and the illumination brightness.

It can be understood that the light-emitting device 100 can also be bent in other shapes to control the illumination brightness and the illumination angle of the light-emitting device 100, such that the light-emitting device 100 can be applied to various application scenarios. The shape of the light-emitting device 100 after bending is not limited herein.

Referring to FIG. 1, in a case that the flexible screen support member 102 is disposed at the side of the surface light source 103 away from the flexible screen 101, the surface light source 103 further includes a light guide plate 106. The light guide plate 106 is disposed between the multiple SMD LEDs 105 and the flexible screen 101 to enable the illumination of light emitted from the flexible screen 101 uniform.

In this embodiment, referring to FIG. 1, the light guide plate 106 is bendable. The light guide plate 106 is bent following the bending of the flexible screen support member 102 during bending the flexible screen support member 102.

Further, referring to FIG. 1, the light guide plate 106 and the flexible screen support member 102 are both made from the heat-dissipating materials to facilitate the diffusion of heat generated by the surface light source 103. In other embodiments, in a case that the light-emitting device 100 is applied to a terminal, the light-emitting device 100 further includes a heat-dissipating member disposed around the surface light source 103. The heat-dissipating member is connected to the surface light source 103 and a casing of the terminal to facilitate heat dissipation of the surface light source 103.

Referring to FIG. 7, the surface light source 103 includes the flexible circuit board 104 and the multiple SMD LEDs 105 attached to the flexible circuit board 104. The multiple SMD LEDs 105 are evenly laid on the flexible circuit board 104 to enable the illumination of the flexible screen 101 uniform. The multiple SMD LEDs 105 can be arranged in an array on the flexible circuit board 104. In other embodiments, the multiple SMD LEDs 105 can also be arranged around a central region of the flexible circuit board 104. Alternatively, the multiple SMD LEDs 105 can be randomly laid on the flexible circuit board 104, for example, the multiple SMD LEDs 105 are combined into LED strips, and the LED strips are attached to the flexible circuit board 104, or the like.

Referring to FIG. 9, a light-reflecting layer 107 is further disposed on the flexible circuit board 104 and arranged around the multiple SMD LEDs 105, such that part of light from the multiple SMD LEDs 105 is emitted to the light-reflecting layer 107, and the part of light is reflected by the light-reflecting layer 107 and exits from the flexible screen 101. As an embodiment, the light-reflecting layer 107 is disposed on a region of the flexible circuit board 104 other than a region where the multiple SMD LEDs 105 and some other components are disposed. The light-reflecting layer 107 may be a metal coating layer arranged on the flexible circuit board 104. The light-reflecting layer 107 may coat part of the flexible circuit board 104, so as to avoid electronic circuits and the multiple SMD LEDs 105 on the flexible circuit board 104 and to prevent the electronic circuits and the multiple SMD LEDs 105 on the flexible circuit board 104 from being short.

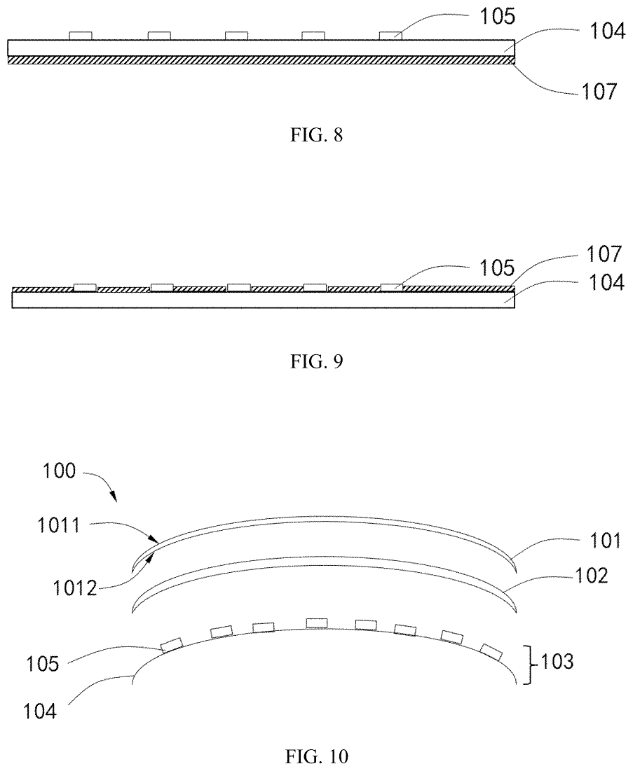

Referring to FIG. 8, in other embodiments, the flexible circuit board 104 may be made from a transparent material. The light-reflecting layer 107 can be disposed on a surface of the flexible circuit board 104 away from the multiple SMD LEDs 105.

### Second Embodiment

Referring to FIG. 10, the second embodiment is different from the first embodiment in that the flexible screen support member 102 is disposed between the surface light source 103 and the flexible screen 101. The flexible screen support member 102 supports the flexible screen 101, such that the shape of the flexible screen 101 and the shape of the surface light source 103 vary following the variation in the shape of the flexible screen support member 102.

In an embodiment, the flexible screen support member 101 is made from a light guide material. The flexible screen support member 101 can be used as a light guide plate of the surface light source 103, and thus there is no necessary to provide another light guide plate, thereby reducing a thickness of the light-emitting device 100 and simplifying a structure of the light-emitting device 100, and accordingly, manufacturing cost of the light-emitting device 100 is reduced.

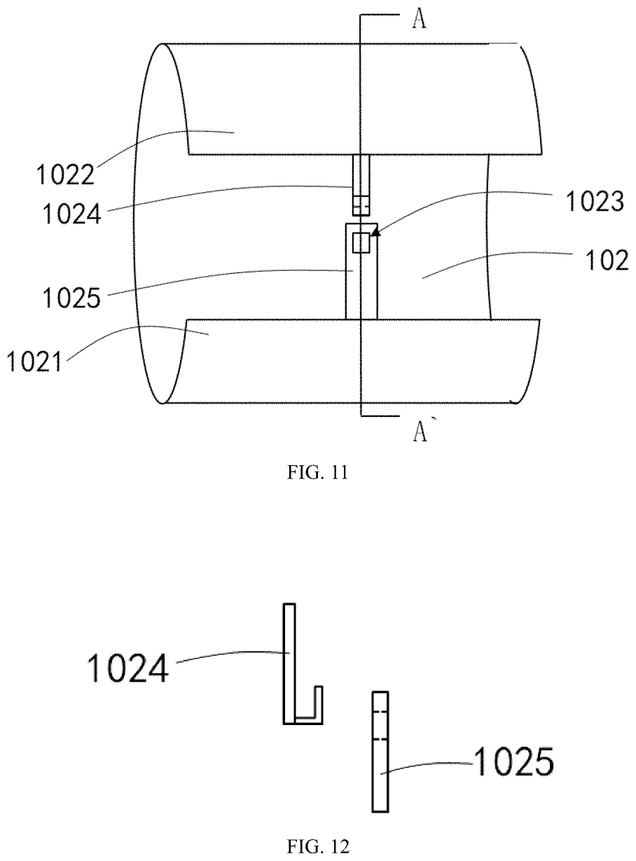

Referring to FIG. 11 and FIG. 12, in an embodiment, the flexible screen support member 102 includes a first end 1021 and a second end 1022 opposite the first end 1021. Bending of the flexible screen support member 102 enables the first end 1021 and the second end 1022 to be close to each other. The light-emitting device further includes an engaging member 1023 having a snap portion 1024 and a hook portion 1025. The snap portion 1024 is disposed at the first end 1021 and the hook portion 1025 is disposed at the second end 1022. The snap portion 1024 and the hook portion 1025 are able to be engaged with each other, enabling the first end 1021 and the second end 1022 to be engaged with each other. Specifically, the engaging member 1023 includes the snap portion 1024 disposed at the first end 1021 and the hook portion 1025 disposed at the second end 1022. The snap portion 1024 and the hook portion 1025 are able to be engaged with each other to realize wearing the light-emitting device 100 on a wrist, so as to prevent part of the light-emitting surface of the flexible screen 101 from being covered when the light-emitting device 100 is held by a hand. Meanwhile, the light-emitting device 100 can be worn on the wrist for illumination, rather than be held by hand, thereby increasing the portability of the light-emitting device 100. Alternatively, the snap portion 1024 is disposed at the second end 1022 and the hook portion 1025 is disposed at the first end 1021, such that the first end 1021 and the second end 1022 can be engaged with each other. In other embodiments, the engaging member 1023 may also be a magnetic structure or other engaging structure, which is not limited herein.

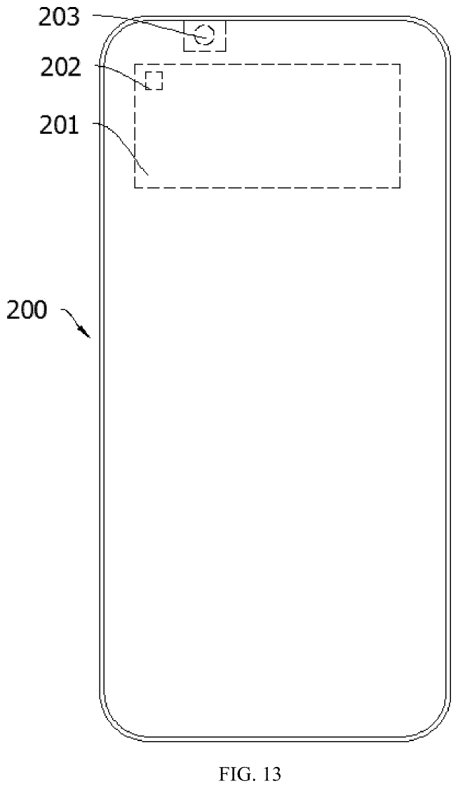

Referring to FIG. 1 to FIG. 14, FIG. 13 illustrates a terminal 200 according to the present disclosure. The terminal 200 includes the light-emitting device 100 of any of the above embodiments and further includes a bending sensing chip 202 and a mainboard 201. The bending sensing chip 202 and the mainboard 201 are disposed on the flexible screen support member 102. The bending sensing chip 202 and the surface light source 103 are both electrically coupled to the mainboard 201. The bending sensing chip 202 is attached to the flexible screen support member 102. The bending sensing chip 202 can be attached to a surface of the flexible screen support member 102 close to the surface light source 103. Alternatively, the bending sensing chip 202 can be attached to a surface of the flexible screen support member 102 away from the surface light source 103. In other embodiments, the bending sensing chip 202 may also be disposed on the flexible screen 101 or the flexible circuit board 104. The bending sensing chip 202 is configured to sense a bending degree of the flexible screen support member 102. The mainboard 201 is configured to adjust the brightness of the surface light source 103 according to the bending degree of the flexible screen support member 102. For example, when the bending degree of the flexible screen support member 102 increases, the mainboard 201 controls increment of the brightness of the surface light source 103, and when the bending degree of the flexible screen support member 102 is reduced, the mainboard 201 controls reduction of the brightness of the light of the surface light source 103. Alternatively, when the bending degree of the flexible screen support member 102 increases, the mainboard 201 controls reduction of the brightness of the surface light source 103, and when the bending degree of the flexible screen support member 102 is reduced, the mainboard 201 controls increment of the brightness of the light of the surface light source 103. In this manner, the brightness of the terminal 200 is controlled based on the bending degree of the flexible screen support member 102, thereby improving user experience and facilitating adjustment of the brightness.

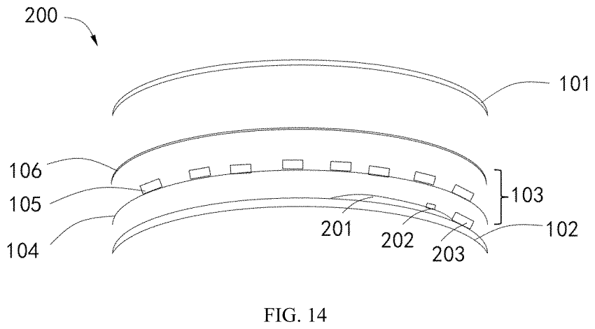

In an embodiment, as illustrated in FIG. 14, the terminal 200 further includes a camera module 203. The camera module 203 is disposed on the flexible screen support member 102 and electrically coupled to the mainboard 201. When the camera module 203 is operating in ambient with low brightness, the surface light source 103 is controlled to emit light by the mainboard 201, so as to increase the brightness of the current ambient to meet the requirements of the brightness for self-photographing or photography.

In an embodiment, as illustrated in FIG. 14, the camera module 203 can be slidably connected to the flexible screen support member 102. When the camera module 203 is not in use, the flexible screen 101 covers the camera module 203. When the camera module 203 is needed to be used, the camera module 203 slides out of the flexible screen support member 102 for use.

The above descriptions are preferred embodiments of the present disclosure, and it is noted that various improvements and modifications can be made without departing from the principle of the present disclosure to those of ordinary skill in the art, and the improvements and the modifications are also considered as the protection scope of the present disclosure.

What is claimed is:

1. A light-emitting device, comprising:
a flexible screen, comprising an exit light surface and an incident light surface opposite the exit light surface; and
a surface light source attached to the incident light surface and configured to emit light passing through the incident light surface and exiting from the exit light surface.

2. The light-emitting device of claim 1, further comprising a flexible screen support member, wherein the flexible screen support member, the flexible screen, and the surface light source are stacked together, and wherein the flexible screen support member is disposed at a side of the surface light source away from the flexible screen.

3. The light-emitting device of claim 1, further comprising a flexible screen support member, wherein the flexible screen support member, the flexible screen, and the surface light source are stacked together, and wherein the flexible screen support member is disposed between the surface light source and the flexible screen.

4. The light-emitting device of claim 3, wherein the flexible screen support member is made from a light guide material.

5. The light-emitting device of claim 2, wherein the surface light source is attached to the flexible screen support member.

6. The light-emitting device of claim 5, wherein the flexible screen support member is bendable, wherein the flexible screen support member is able to be bent to be in one of a C-shape and an S-shape, enabling the flexible screen and the surface light source to be bent to be in one of a C-shape and an S-shape.

7. The light-emitting device of claim 2, further comprising an engaging member having a snap portion and a hook portion able to be engaged with the snap portion;
wherein the flexible screen support member comprises a first end and a second end opposite the first end, and wherein the snap portion is disposed at the first end and the hook portion is disposed at the second end, enabling the first end and the second to be engaged with each other via the engaging member during bending the flexible screen support member.

8. The light-emitting device of claim 7, wherein brightness of the surface light source varies during switching the flexible screen from flattened status to bent status.

9. The light-emitting device of claim 8, further comprising a bending sensing chip and a mainboard, wherein the bending sensing chip and the mainboard are disposed on the flexible screen support member, and wherein the bending sensing chip and the surface light source are electrically coupled with the mainboard.

10. The light-emitting device of claim 2, wherein the surface light source is an organic light-emitting diode light source.

11. The light-emitting device of claim 2, wherein the surface light source comprises a flexible circuit board and a plurality of surface-mount device light-emitting diodes attached to the flexible circuit board, and wherein the plurality of surface-mount device light-emitting diodes are disposed at a side of the flexible circuit board close to the flexible screen.

12. The light-emitting device of claim 11, wherein the surface light source further comprises a light guide plate disposed between the plurality of surface-mount device light-emitting diodes and the incident light surface of the flexible screen.

13. The light-emitting device of claim 12, wherein the light guide plate is bendable, and wherein the light guide plate is bent following bending of the flexible screen support member during bending the flexible screen support member.

14. The light-emitting device of claim 12, wherein the light guide plate and the flexible screen support member are both made from heat-dissipating materials.

15. The light-emitting device of claim 12, further comprising a light-reflecting layer disposed on the flexible circuit board and arranged around the plurality of surface-mount device light-emitting diodes, such that part of light from the plurality of surface-mount device light-emitting diodes is emitted to the light-reflecting layer, and the part of light is reflected by the light-reflecting layer and exits from the flexible screen.

16. The light-emitting device of claim 2, wherein the flexible screen comprises a display region and a non-display region surrounding the display region, and wherein a ratio of an area of the display region to an area of the non-display region is greater than 4:1.

17. The light-emitting device of claim 16, wherein a projection of the display region of the flexible screen in a direction toward the surface light source falls on the surface light source.

18. A terminal comprising:
a flexible screen comprising an exit light surface and an incident light surface opposite the exit light surface;
a surface light source attached to the incident light surface and configured to emit light passing through the incident light surface and exiting from the exit light surface;
a flexible screen support member operable to support the flexible screen;
a bending sensing chip disposed on the flexible screen support member, and configured to sense a bending degree of the flexile screen support member; and
a mainboard configured to control brightness of the light emitted by the surface light source according to the bending degree of the flexible screen support member.

19. The terminal of claim 18, further comprising a camera module slidably connected to the flexible screen support member.

20. A terminal comprising:
a flexible screen comprising an exit light surface and an incident light surface opposite the exit light surface;
a surface light source attached to the incident light surface and configured to emit light passing through the incident light surface and exiting from the exit light surface; and
a mainboard configured to control a variation of brightness of the light emitted by the surface light source according to a variation of a shape of the flexible screen.
